(19) United States
(12) Patent Application Publication
(10) Pub. No.: US 2003/0034581 A1
(43) Pub. Date: Feb. 20, 2003

(54) Method and equipment for making plastic floor tiles with one round of processing

(75) Inventor: Kuang Pao Lo, Tainan (TW)

Correspondence Address: Kuang-Pao Lo, No. 17, ALLEY 13, LANE 528, DA SHING ST., TAINAN, TW

(73) Assignee: DELIGHT PLASTIC CO., LTD., TAINAN (TW)

(21) Appl. No.: 09/933,210

(22) Filed: Aug. 17, 2001

(51) Int. Cl. B29C 43/22; B29C 43/46

(52) U.S. Cl. 264/74; 264/76; 264/280; 425/363; 425/384

(57) ABSTRACT

A method and equipment for making plastic floor tiles of different thickness includes polyvinyl chloride (PVC) of one color or different colors heated first and then moved to a first press roller unit of a compress extending machine to be compressed into a first half-finished product. Then this first half-finished product get through a second and a third press roller units to be respectively compressed into a second half-finished product and a third half-finished (or finished) product. Further, a heating device is provided respectively beside the second and the third press roller units for heating the half-finished products with balanced temperature. Thus, the half-finished product is properly fused to make finished plastic floor tiles with different thickness from 0.5 mm to 3 mm.

### BACKGROUND OF THE INVENTION

This invention relates to a method and equipment for making plastic floor tiles, particularly to one possible to make plastic floor tiles of different thickness with one round of processing.

For the present, the thickness of a plastic floor tile made by a conventional compress-extending machine is less than 0.5 mm. If a plastic floor tile with its thickness over 0.5 mm is to be made, more than two layers of the plastic floor tiles have to be processed, to fuse them together to form a plastic floor tile with thickness more than 0.5 mm. This problem of complicated processing hasn't been solved so far since it was disclosed in a Taiwan Patent No. 50877.

Specifically, to make plastic floor tiles of different thickness, two plastic floor tiles with 0.5 mm thick have to be heated to a proper temperature (about 180° C. to 220° C.) first to permit these two plastic floor tiles fused together, and, if a plastic floor tile three times thicker than an original one is required, a third plastic floor tile has to be added for processing once more, thus not only complicating processing, but also liable to render respective layer of such fused plastic floor tile detached automatically due to high temperature.

Besides, the curving and irregular lines on the surface of a conventional plastic floor tile are commonly formed in a way of gluing, pressing or printing, but such curving and irregular lines are possible to disappear after used and rubbed for a long period of time, greatly affecting its aesthetic feeling. Further, the plastic floor tiles made in shape in the disclosed Taiwan Patent No. 50877 are likely to split due to ingredients of the material used.

Another conventional way of making plastic floor tiles is by gluing a plurality of layers together, as shown in FIG. 1. In this way, two or more units of press rollers A1, A2 are provided. Firstly, a sundry-colored bottom plate B is compressed by the press roller unit A1 and then glued together with a white-separating material C and a colored surface material D and finally compressed and pasted together by the press roller unit A2 to form a plastic floor tile (see enclosed No. 1, 2 and 3) with a colored surface. The white separating material C is used in order to prevent the sundry-colored bottom plate B from being seen through the top colored surface to ensure its aesthetic feeling. But such a plastic floor tile formed by pasting together three layers of different grains is likely to reveal the different-colored bottom plate after used and worn off after a certain period of time, spoiling its aesthetic appearance.

### SUMMARY OF THE INVENTION

The objective of this invention is to offer a method and equipment for making plastic floor tiles of different thickness with one round of processing, possible to economize processing time, increase qualified percentage of products and heighten competitive force of products. The features of this invention are described below:

1. In manufacturing method, a long-shaped polyvinyl chloride (PVC) of one color or of different colors is heated and compressed to extend in shape by a cloth-gluing machine, adjustable for freely changing the thickness of a plastic floor tile.

2. In equipment, two heating devices are provided respectively beside the second and the third press roller units, and the temperature of the heating device is set around 800° C. depending on the thickness of plastic floor tiles required.

### BRIEF DESCRIPTION OF DRAWINGS

This invention will be better understood by referring to the accompanying drawings, wherein:

FIG. 1 is a cross-sectional view of a two-stage processing in making a conventional plastic floor tile;

FIG. 2 is a cross-sectional view of a process of making a plastic floor tile of different thickness in the present invention;

FIG. 3 is another cross-sectional view of the process of making a plastic floor tile of different thickness in the present invention;

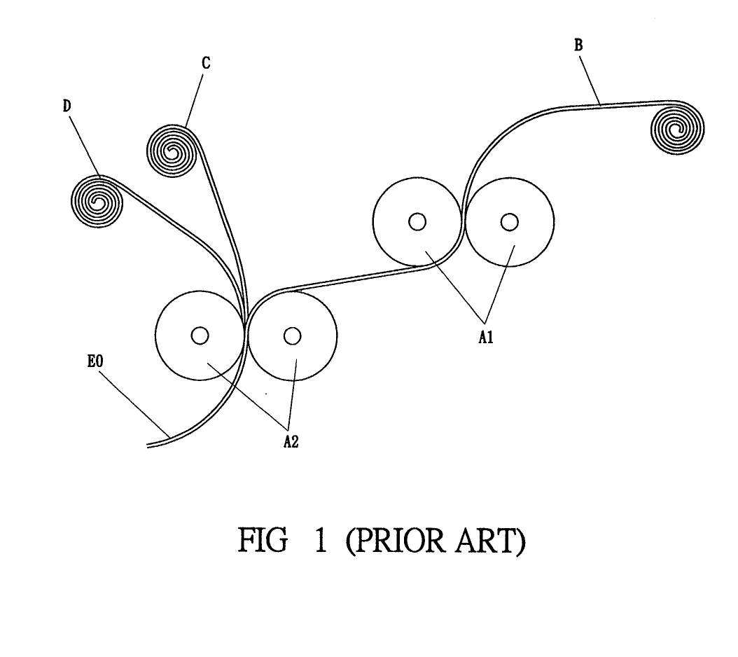

Enclosed No.1: A product made with a conventional method.

Enclosed No.2: Another product made with a conventional method.

Enclosed No.3: Another product made with a conventional method.

Enclosed No.4: A product made with the method in the invention.

### DETAILED DESCRIPTION OF THE PREFERRED EMBODIMENT

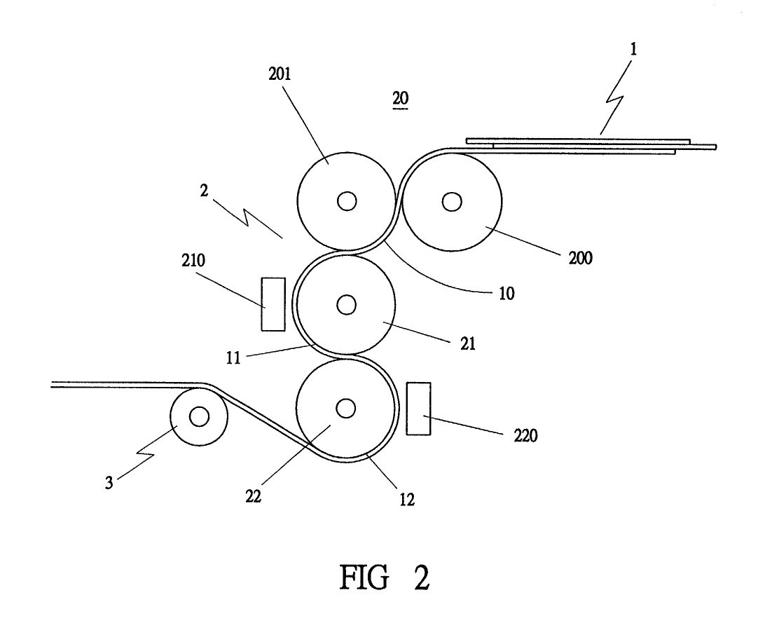

A preferred embodiment of a method and equipment for making plastic floor tiles of different thickness in the present invention, as shown in FIG. 2, includes long polyvinyl chloride (PVC) fed in a compress-extending machine 2 having a plurality of press roller units and two heating devices 210, 220. In this embodiment three roller units are illustrated.

The long polyvinyl chloride (PVC) 1 can be of one color or different colors for producing various colored plastic floor tiles. The long-shaped PVC is first heated and carried to the first press roller unit 20 composed of two press rollers 200 and 201 and then compressed to extend by the first press roller unit 20 and formed into a half-finished product 10, because the press rollers 200 and 201 can automatically generate heat up to 180° C. -220° C. to soften long PVC and make it fused in shape.

Then, this first half-finished product 10 is carried to a second press roller unit 21 consisting of two press rollers 201 and 21. The press roller 21 can also automatically generate heat up to 180° C. -220° C., with a heating device 210 positioned beside it to supply a comparatively high temperature to the first half-finished product 10 to let it completely heated with a balanced temperature and compressed by the second press roller unit 21 so as to make a second half-finished product 11 comparatively thick.

Next, the second half-finished product 11 is moved to a third press roller unit 22 composed of two press rollers 21 and 22, compressed in shape. And, in order to make plastic floor tiles of different thickness, a second heating device 220 is provided beside the press roller 22, having a same function as the first heat-increasing device 210. An ideal temperature generated by the heating devices 210 and 220 is around 800° C., but, actually, a high temperature required can be adjusted according to the thickness of a finished plastic floor tile 12 needed and the speed of manufacturing process.

In brief, with the method and the equipment of this invention, plastic floor tiles of different thickness (from 0.5 mm to 3 mm) can be made with only one round of processing, not only enhancing qualified percentage of products but also increasing their aesthetic appearance and value by marbleizing the plastic floor tiles, as shown in Enclosed photo No. 4. And, if a grain roller 3 is additionally provided behind the compress-extending machine, the plastic floor tiles of this invention can be shaped with various solid grains on surface, with value of products greatly increased.

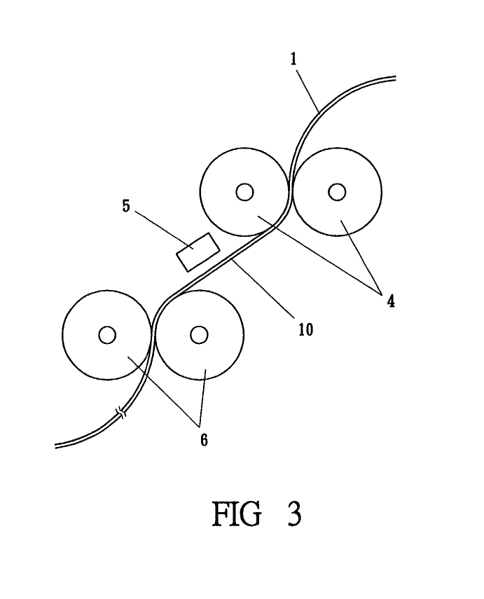

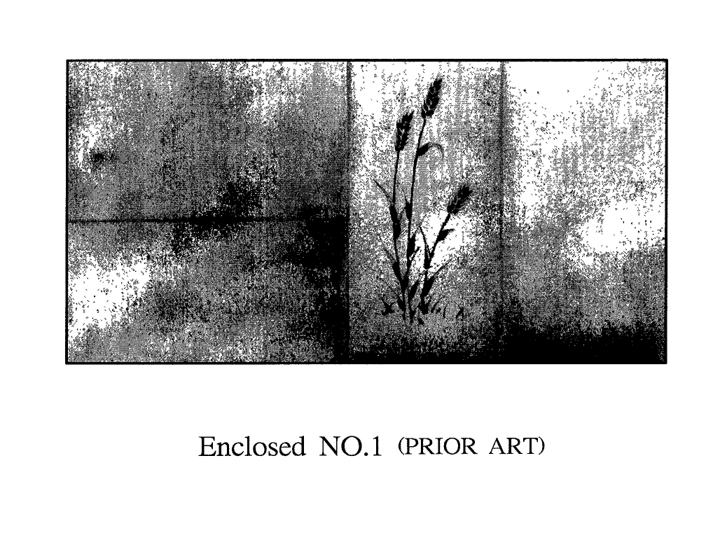

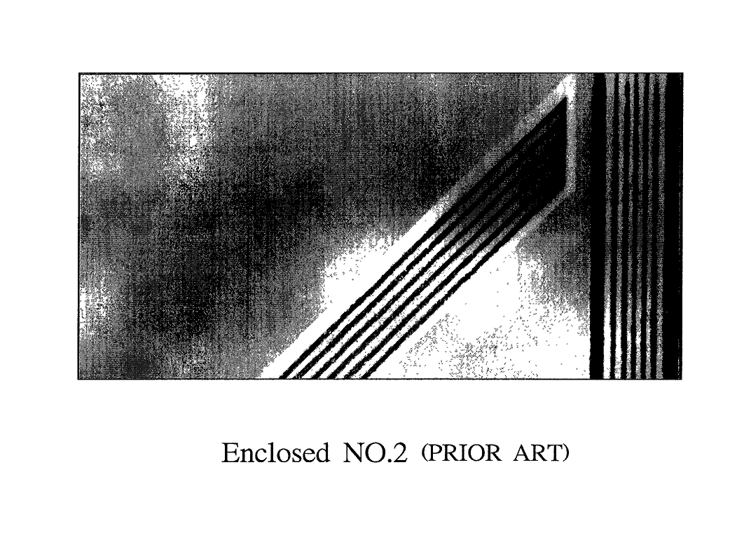

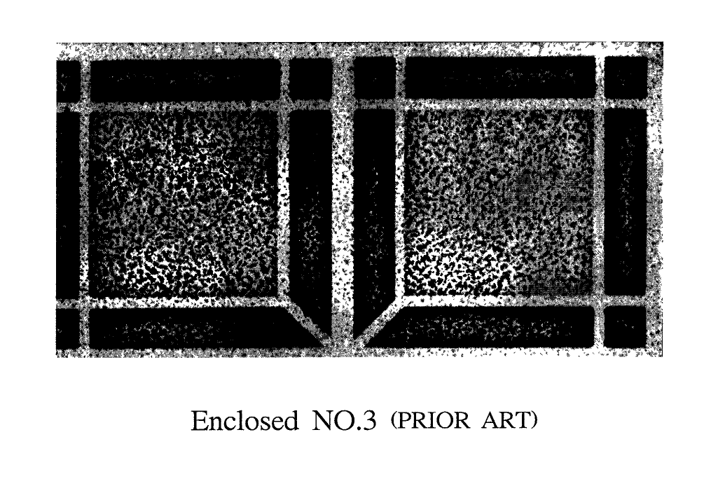

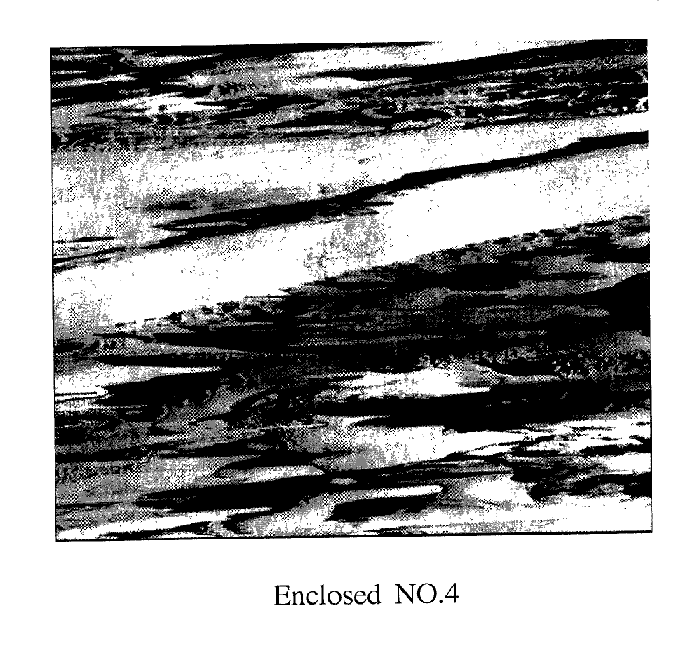

Another preferred embodiment of a method and equipment for making plastic floor tiles of different thickness in the present invention, as shown in FIG. 3, includes long PVC 1 heated and compressed by another roller unit 4 and formed into a first half-finished product 10. Then this 110 half-finished product 10 is heated by one or more heating devices and once more compressed by anther roller unit 6 to finish the plastic floor tiles of this invention with one round of processing, having natural grains on their surface and different thickness. Additionally, the roller units 4 and 6 can be provided with one or more units, and a heating device 5 can be additionally provided in front of the first roller unit 4.

To sum up, the finished plastic floor tile of this invention, as shown in Enclosed No. 4, has the same natural grains inside and outside and these natural grains can keep unchanged even if used for a long time, so that it is capable to keep aesthetic appearance of its surface grains and maintain decorative integration of a floor, and further economizing processing cost, lowering its selling price, elevating qualified percentage of products and increasing competitive force.

While the preferred embodiments of the invention have been described above, it will be recognized and understood that various modifications may be made therein and the appended claims are intended to cover all such modifications that may fall within the spirit and scope of the invention.

What is claimed is:

1. A method for making plastic floor tiles of different thickness with one round of processing comprising plural long materials of polyvinyl chloride (PVC) with one color or different colors, said long PVC heated properly and carried to a compress-extending machine composed of several press roller units, a first one of said press roller unit consisting of two press rollers which properly compress said long PVC to extend and form a first half-finished product, said first half-finished product continuously moved to a second one of said press roller units also composed of two press rollers, with a first heating device provided beside one of said two press rollers, said first half-finished product heated and softened by said first heating device and compressed to extend by said second press roller unit to form a second half-finished product, said second half finished product carried through and compressed by a third press roller unit containing two press rollers, with a second heating device positioned beside one of these two said press rollers, two said heating devices able to generate a high temperature up to 800° C. for heating and softening said first and second half-finished products in a balanced condition, said high temperature adjustable in accordance with the thickness of said plastic floor tile required, said plastic floor tiles of different thickness (from 0.5 mm to 3 mm) capable to be made with one round of processing.

2. The method of making plastic floor tiles of different thickness with one round of processing as claims in claim 1, wherein the temperature of said heating devices is no less than 220° C.

3. The equipment for making plastic floor tiles of different thickness with one round of processing including a compress-extending machine, said compress extending machine composed of a plurality of press roller units, a first one of said press roller unit consisting of two press rollers, said first press roller unit compressing long PVC to extend and form a first half-finished product, then said first half-finished product moved to a second one of said press roller units to be compressed into a comparatively thick product; and,
Characterized by a heating device provided beside said press roller for supplying high temperature to said first and second half-finished products to let them completely heated by balanced temperature so as to make plastic floor tiles with different thickness.

4. The equipment for making plastic floor tiles of different thickness with one round of processing as claimed in claim 3, wherein a heat-increasing device provided in front of each said press roller.
